(19) United States
(12) Patent Application Publication
(10) Pub. No.: US 2011/0208540 A1
(43) Pub. Date: Aug. 25, 2011

(54) EXECUTABLE CLINICAL GUIDELINE AND GUIDELINE TOOL

(75) Inventors: William P. Lord, Fishkill, NY (US); Cornelis Kees Van Zon, Cold Spring, NY (US); Charles Lagor, Dobbs Ferry, NY (US)

(73) Assignee: KONINKLIJKE PHILIPS ELECTRONICS N.V., EINDHOVEN (NL)

(21) Appl. No.: 13/125,817

(22) PCT Filed: Oct. 28, 2009
(86) PCT No.: PCT/IB09/54775

§ 371 Date: Apr. 25, 2011

Related U.S. Application Data
(60) Provisional application No. 61/111,912, filed on Nov. 6, 2008.

(51) Int. Cl. G06Q 50/00

(52) U.S. Cl. 705/2

(57) ABSTRACT

A system and method for receiving an input including a condition corresponding to a patient, retrieving a set of recommendations corresponding to the condition, displaying at least a portion of the set of recommendations to a user, receiving an input that one of the recommendations has been completed and modifying the display of the recommendations based on the input that the one of the recommendations has been completed.

### BACKGROUND

Healthcare providers standardize practices by implementing guidelines for frequently performed medical procedures or other processes. Performance of these guidelines may take place in time-critical situations or emergencies where it is difficult to track the performance of guidelines, or perform the guidelines exactly as prescribed. There is a long felt need to solve the above-identified problem(s).

### SUMMARY OF THE INVENTION

The exemplary embodiments described herein include a method for receiving an input including a condition corresponding to a patient, retrieving a set of recommendations corresponding to the condition, displaying at least a portion of the set of recommendations to a user, receiving an input that one of the recommendations has been completed and modifying the display of the recommendations based on the input that the one of the recommendations has been completed.

The exemplary embodiments described herein further include a system having a processor, a display and a memory. The processor receiving an input of a condition corresponding to a patient and retrieving, from the memory, a set of recommendations corresponding to the condition, the display displaying the set of recommendations to a user, the processor receiving an input that one of the recommendations has been completed and sending instructions to the display to modify the display of the recommendations based on the input that the one of the recommendations has been completed.

The exemplary embodiments described herein further include a computer readable storage medium including a set of instructions that are executable by a processor, the set of instructions being executable to receive an input including a condition corresponding to a patient, retrieve a set of recommendations corresponding to the condition, display at least a portion of the set of recommendations to a user, receive an input that one of the recommendations has been completed and modify the display of the recommendations based on the input that the one of the recommendations has been completed.

### BRIEF DESCRIPTION OF THE DRAWINGS

FIG. 1 shows an exemplary system for coordinating healthcare guidelines according to the present invention.

FIG. 2 shows an exemplary method for coordinating healthcare guidelines according to the present invention.

### DETAILED DESCRIPTION

The exemplary embodiments of the present disclosure may be further understood with reference to the following description and the appended drawings, wherein like elements are referred to with the same reference numerals. The exemplary embodiments describe systems and methods for coordinating the performance of clinical guidelines by which healthcare professionals may treat patients with specific conditions.

As used in this disclosure, a “guideline” is a documented set of recommendations for healthcare professionals on how to optimally treat and manage patients with specific diseases and/or conditions. These guidelines are typically not intended to be rigid rules; rather, they are intended to be advice to guide the users thereof. Many such guidelines are maintained by the National Guideline Clearinghouse and available at http://www.guideline.gov. Various efforts have been made to computerize or otherwise automate handling of guidelines, but suffer from flaws including restriction of users to a prescribed order of events, which is often not practical in a clinical setting. For example, the condition of a patient often changes, which cannot be taken into account by a prescribed order of events. The exemplary embodiments disclosed herein may overcome these disadvantages and provide further advantages in guideline handling.

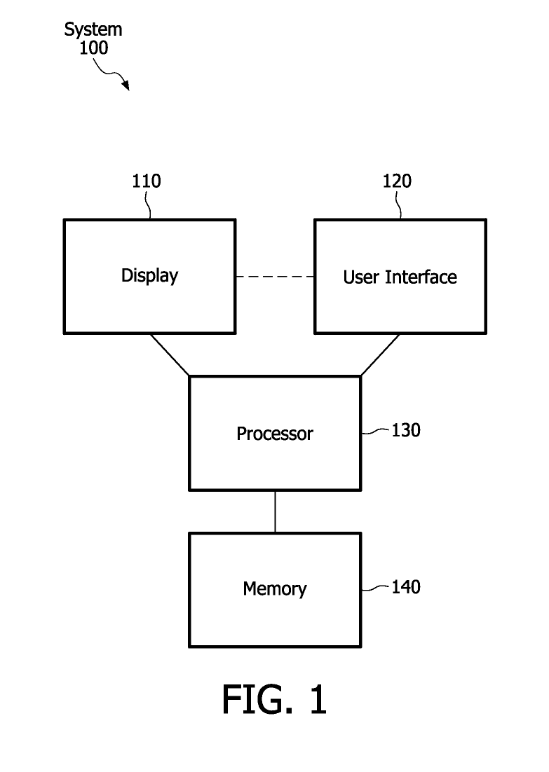

FIG. 1 illustrates an exemplary system 100 for use in coordinating the performance of guidelines, including the tracking of performance of guidelines. The system 100 may be dedicated to this purpose alone, or may also be used to perform other tasks (monitoring patient information or vital signs, etc.). The system 100 may be standalone or may be part of a network spanning one or multiple healthcare provision sites.

The system 100 includes, for example, a display 110 (e.g., a conventional display, a touch-sensitive display, a number of display devices, etc.), a user interface 120 (e.g., a touch-sensitive means on a display, a keyboard, a mouse, a touchpad, etc.), a processor 130 capable of coordinating the performance of guidelines in the manner described below and a memory 140 (e.g., data storage such as a hard drive and dynamic or non-volatile memory such as RAM). The system 100 may further optionally include other components such as for example, patient monitoring devices such as a heart rate monitor, a blood pressure monitor, glucometer, etc.

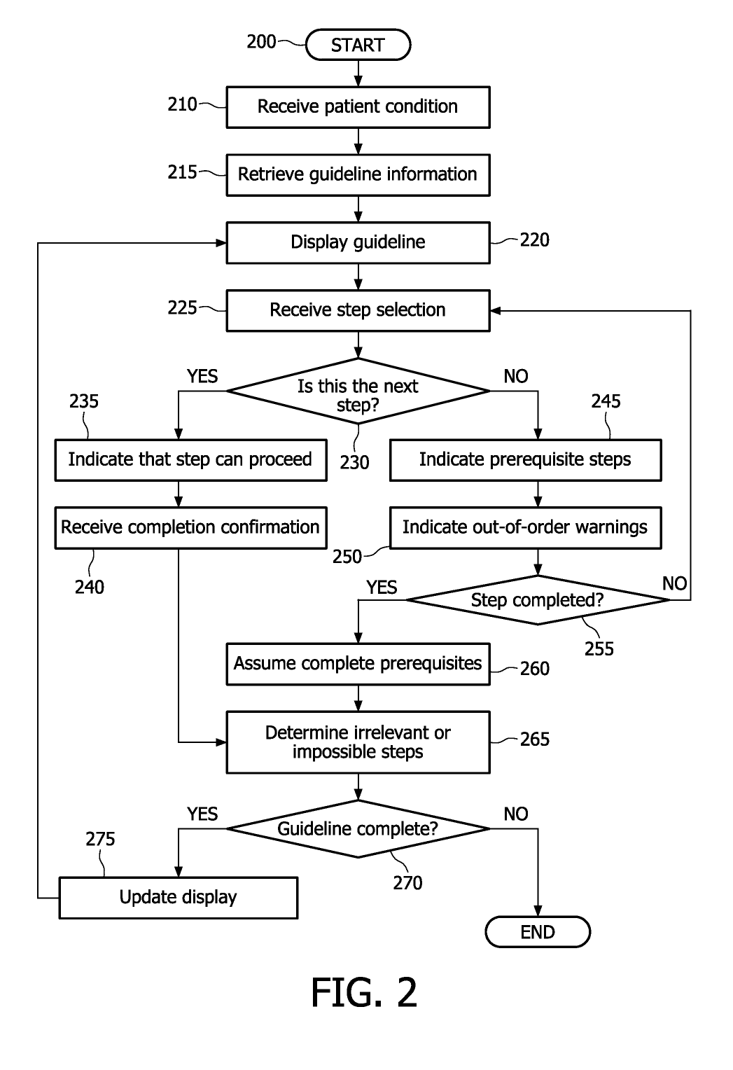

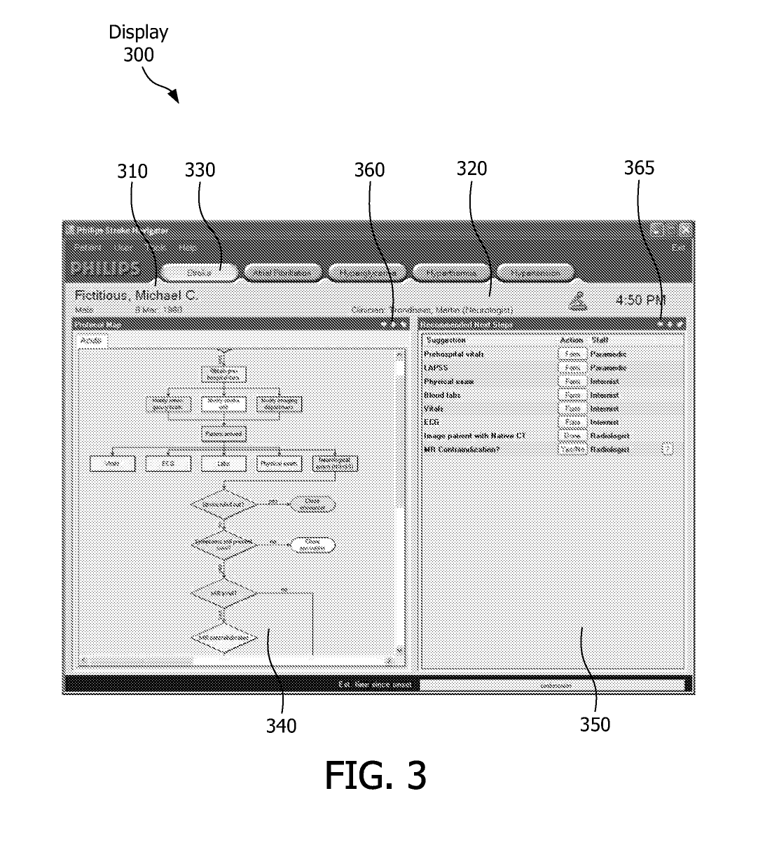

FIG. 2 illustrates an exemplary method 200 for coordinating the performance of guidelines. In the exemplary embodiment, the method 200 is executed, for example, by the system 100 described above with reference to FIG. 1. However, the method 200 may be executed by any system capable of providing and coordinating guidelines as described herein. In step 210, a patient condition is received. This condition is, for example, a disease, an injury, an elective procedure, a test or a group of tests, or any other condition that has a recommended set of steps associated therewith. The system 100 receives the patient condition via user input (e.g., a user selects from a variety of conditions displayed on the display 110 using the user interface 120) or may determine the patient condition via input received from input devices such as a heart rate monitor, a blood pressure monitor, glucometer, etc (e.g., the system 100 may determine that the patient is having a heart attack based on electrocardiogram information being input into the system 100).

It should be noted that when a patient first arrives (e.g., at a hospital, clinic, doctor's office, ambulance, etc.), it may not always be known what the patient's condition is and what guideline should be used. Thus, in such situations, this step may be preceded by the use of a diagnostic guideline. Similarly, in an emergency medical situation (e.g., EMS, an emergency department, etc.), this may be preceded by the use of a triage guideline to prioritize patients.

In step 215, a guideline corresponding to the received condition is retrieved. Guidelines may be stored locally (e.g., in memory 140 of system 100) and retrieved internally, or may be stored and maintained remotely (e.g., at a central location where all guidelines are maintained for a particular hospital, healthcare network, etc.). A guideline typically includes a recommended set of steps to be performed in order to properly treat or resolve the patient condition. A guideline may be linear (e.g., a set of steps to be performed sequentially), may include steps to be performed in parallel (e.g., simultaneously) with one another, or may include branches at which there are two or more steps to be chosen from based on the results of a prior step, etc.

In step 220, the guideline is displayed to a user (e.g., via display 110). The guideline may be displayed in part (e.g., display of the first step, the first two steps, etc.) or in full. The user may be able to choose among different display options. If the system 100 is simultaneously handling other tasks, the guideline may be displayed only in part of the display 110, while the remainder of the display 110 may display data unrelated to the guideline and/or related to handling the other tasks. Alternatively, the display may highlight steps that are next in sequence and/or gray out steps that are not available at the moment (e.g., if they are no longer applicable because a previously-completed step renders them irrelevant, if they are not possible because prerequisite steps have not yet been completed, etc.) Additionally, steps in various states of completion (e.g., not yet reached, skipped, disabled, active, partially complete, complete, inferred complete/activated/disabled, etc.) may be classified graphically (e.g., using different colors, using different borders, etc.).

In step 225, the system 100 receives a selection of a step from a user. The selection is accomplished, for example, using the user interface 120 (e.g., by a mouse click, by touching a touch-sensitive display device, etc.). This step selection indicates that a step within the guideline is being considered for performance, and will thus cause the system to evaluate whether it is appropriate to perform the selected step at the time of selection, as will be described below.

In step 230, the system 100 evaluates the step selection received in step 225 to determine whether it is the next step in the guideline. If it is the appropriate next step, the method continues in step 235, wherein the system 100 indicates to the user (e.g., via a message shown on display 110, via an indicator tone, etc.) that the selected step can proceed.

Next, in step 240, the system 100 receives completion confirmation from the user when the step is completed (e.g., via a further mouse click or other input, typically similar to that used in step 225).

Alternately, if the system 100 determines that the selected step is out of sequence, the method proceeds to step 245, wherein the system 100 indicates to the user that there are other steps that should be performed first. This indication is accomplished, for example, by highlighting these prerequisite steps on the display 110 and thereby informing the user about the steps that need to be completed to reach a particular step or goal. If multiple paths to the selected step exist, the system 100 may indicate all alternatives. Next, in step 250, the system 100 may further provide warnings associated with performing the selected step out of order. For example, in a guideline for stroke treatment, the completion of a step ruling out the occurrence of a stroke prior to the completion of a step indicating the completion of required laboratory tests would be flagged. The flagging could be, for example, the step being highlighted (such as by flashing, color coding an outline or the entire step) with a warning message. Warnings may be provided through display 110, by playing an indicator tone, etc. While the system 100 may allow steps within a guideline to be completed out of sequence, there may be medical reasons for not doing so. The appropriate response to such a warning may then be determined at the discretion of the individual clinical site, by the individual health care practitioner, etc.

Subsequently, in step 255, the system waits to receive an indication that the selected step has been completed. This indication may be accomplished in the same manner as described above for step 240. If the user has elected not to complete the out-of-sequence step, the method returns to step 225 and the system waits to receive a new step selection. If the user indicates that the selected step has been completed, the method continues to step 260, wherein the system 100 infers that any prerequisites to the selected step have been completed in order to reach the selected step. This may be useful in environments such as emergency rooms, where there is not always an opportunity to record every action when it is completed. For example, if the selected step is to give the patient an ECG, then the system may infer that the patient has been admitted.

In step 265, which follows either step 240 or step 260, the system 100 determines whether any steps have been made irrelevant or impossible by the just-completed step. In one example, where two different types of scans may be options for testing a patient for a particular condition, if the first of the two has just been completed, the second may no longer be applicable. In another example, if a decision step “Stroke ruled out?” has been answered negatively, a step “Close encounter” may not be possible. As described above, such a step may be displayed as grayed-out in the display 100; however, a user may still be able to perform such a step if desired, such as for confirmation of the results of the previously-performed scan.

After step 265, in step 270 the system 100 determines whether the guideline has been completed. The standard for completion may vary depending on the type of guideline being used (e.g., completion of a test, performance of a surgery, patient discharge, etc.). If the guideline is not complete, then in step 275 the system 100 updates the guideline with the changes described above (e.g., completion of the selected step, completion of prerequisite steps, identification of irrelevant/impossible steps, etc.). After the guideline has been updated, the method returns to step 220, wherein the updated guideline is displayed to the user. Alternately, if the system 100 determines that the guideline has been completed, the method terminates after step 270.

The system 100 may be capable of sequentially replaying the step-by-step performance of all guideline steps performed in a particular patient's case. This operation is useful, for example, to review the actions of a healthcare provider to ensure that the actions are being performed efficiently. Such an operation may be initiated during the performance of the method 200 or retrospectively at another time.

Completed steps within a guideline may have an “undo” option for reverting the guideline to a point before they were completed; this is useful if a step was designated as “complete erroneously”, if a step was completed incorrectly and needs to be repeated, etc.

In another exemplary embodiment, the system 100 may be adapted to allow multiple steps within a guideline to proceed simultaneously, even if it is recommended that they should be performed sequentially. This may also be possible for guidelines including steps that are intended to be performed simultaneously.

FIG. 3 shows a Graphical User Interface (“GUI”) 300 that may be provided to a user, such as via the display 110. Information provided on GUI 300 may include patient identification information 310, physician identification information 320, selection tabs 330, 332, 334, 336 and 338 for navigating among various active guidelines, a graphical representation 340 of the active guideline and a list of recommended next steps 350. Windows on the GUI 300 may be resized using sizing icons 360 and 365.

The status of individual steps within a guideline, as shown in the graphical representation 340, may be graphically represented. For example, a step that has been explicitly indicated complete is indicated with a blue background, while a step that has been inferred complete (e.g., as discussed above with reference to step 260) is indicated with a blue background and a red border. An inactive step is indicated with a white background, while a step that has been inferred to be irrelevant (e.g., as discussed above with reference to step 265) is indicated with a gray background and a red border. An active step is indicated with a flesh-toned background, and a partially-completed step is indicated with a background that is partially blue and partially flesh-toned, with the amount of blue indicating the percentage complete.

In another exemplary embodiment, the information provided by a system (e.g., in this embodiment, a single workstation in a broader health care network) may be specific to the user of the system. In such an embodiment, rather than displaying a full guideline for a disease and/or patient, the user would be provided with only the steps that concerned him/her. For example, for a guideline relating to a CT exam, an x-ray technician's workstation would display only the step of the guideline relating to the performance of the CT scan itself; subsequently, when the scan is completed, a radiologist's workstation would display only the step of the guideline relating to the interpretation of the scan.

In addition, a single workstation may display multiple windows having different steps of a guideline based on the users that are looking at the guideline. For example, in an emergency room situation, there may be a physician and a nurse and the display may have a display window open for each of the physician and nurse displaying the step or steps of the guideline that are appropriate for the physician in the physician's window and the step or steps of the guideline that are appropriate for the nurse in the nurse's window.

Furthermore, the user input device may allow for an input to be received to switch displays of guidelines for various user's and/or job descriptions. For example, a guideline may be being displayed for a triage nurse who will perform the functions for the patient associated with a triage nurse. The responsibility for the patient may then be assumed by another nurse, for example, an acute care nurse. The acute care nurse may provide the system displaying the guideline with an input indicating that an acute care nurse is now taking care of the patient so that the appropriate guideline steps associated with that job function are displayed.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalents.

It is also noted that the claims may include reference signs/numerals in accordance with PCT Rule 6.2(b). However, the present claims should not be considered to be limited to the exemplary embodiments corresponding to the reference signs/numerals.

What is claimed is:

1. A method, comprising:
receiving (210) an input including a condition corresponding to a patient;
retrieving (215) a set of recommendations corresponding to the condition;
displaying (220) at least a portion of the set of recommendations to a user;
receiving (240, 255) an input that one of the recommendations has been completed; and
modifying (275) the display of the recommendations based on the input that the one of the recommendations has been completed.

2. The method of claim 1, wherein the modifying includes indicating that the one of the recommendations has been completed.

3. The method of claim 1, wherein the modifying includes indicating that at least one other recommendation has been completed based on the input that the one recommendation is complete.

4. The method of claim 1, wherein the modifying includes indicating at least one other recommendation is one of irrelevant or not possible to complete based on the input that the one recommendation is complete.

5. The method of claim 1, wherein the modifying includes displaying a plurality of recommendations including at least two separate paths of recommendations based on the input that the one recommendation is complete.

6. The method of claim 1, further comprising:
receiving (225), from a user, a selection of one of the set of recommendations, the selected one of the recommendations deviating from a sequence of the set of recommendations; and
providing (245, 250) the user with information relating to the deviating recommendation.

7. The method of claim 6, wherein the information is one of a further one of the recommendations that precedes the selected one of the recommendations (245) and a warning relating to the selected one of the recommendations (250).

8. The method of claim 1, further comprising:
receiving a further input indicating a job function of a user; and
modifying the display of the recommendations based on the job function of the user.

9. The method of claim 1, wherein the input is one of a user input and a parameter input.

10. The method of claim 1, wherein the modifying the display includes one of altering a color of the one of the recommendations and altering a border surrounding the one of the recommendations.

11. A system, comprising:
a processor (130);
a display (110); and
a memory (140),
the processor (130) receiving an input of a condition corresponding to a patient and retrieving, from the memory (140), a set of recommendations corresponding to the condition, the display (110) displaying the set of recommendations to a user, the processor (130) receiving an input that one of the recommendations has been completed and sending instructions to the display (110) to modify the display of the recommendations based on the input that the one of the recommendations has been completed.

12. The system of claim 11, wherein the instructions to modify the display (110) includes indicating that the one of the recommendations has been completed.

13. The system of claim 11, wherein the instructions to modify the display (110) includes indicating that at least one other recommendation has been completed based on the input that the one recommendation is complete.

14. The system of claim 11, wherein the instructions to modify the display (110) includes indicating at least one other recommendation is one of irrelevant or not possible to complete based on the input that the one recommendation is complete.

15. The system of claim 11, wherein the instructions to modify the display (110) includes displaying a plurality of recommendations including at least two separate paths of recommendations based on the input that the one recommendation is complete.

16. The system of claim 11, further comprising:
a user interface device (120) to receive the input.

17. The system of claim 16, wherein the user interface device (120) is one of a keyboard, a mouse, a touch sensitive screen, and a touchpad.

18. The system of claim 16, wherein the processor (130) receives via the user interface device (120) a selection of one of the set of recommendations, the selected one of the recommendations deviating from a sequence of the set of recommendations, the processor (130) sending further instructions to the display (110) to provide the user with information relating to the deviating recommendation.

19. The system of claim 18, wherein the information is one of a further one of the recommendations that precedes the selected one of the recommendations and a warning relating to the selected one of the recommendations.

20. A computer readable storage medium storing a set of instructions that are executable by a processor, the set of instructions being executable to:
receive (210) an input including a condition corresponding to a patient;
retrieve (215) a set of recommendations corresponding to the condition;
display (220) at least a portion of the set of recommendations to a user;
receive (240, 255) an input that one of the recommendations has been completed; and
modify (275) the display of the recommendations based on the input that the one of the recommendations has been completed.
